(19) United States
(12) Patent Application Publication
(10) Pub. No.: US 2016/0321725 A1
(43) Pub. Date: Nov. 3, 2016

(54) SYSTEMS AND METHODS FOR GENERATING VEHICLE ADDENDUMS

(71) Applicant: DEALERADDENDUMS, INC., SALT LAKE CITY, UT (US)

(72) Inventor: Allan Tone, Salt Lake City, UT (US)

(21) Appl. No.: 14/701,356

(22) Filed: Apr. 30, 2015

(51) Int. Cl. G06Q 30/06; G06F 17/30; G06Q 10/08; G09F 21/04; G09F 3/00

(52) U.S. Cl. CPC G06Q 30/0623; G09F 21/04; G09F 3/00; G06Q 10/087; G06F 17/30528; G06F 17/30598; G06F 17/30864

(57) ABSTRACT

The present disclosure provides systems and methods for labeling vehicles, for example by generating vehicle labels, such as dealer addendums. The vehicle labels may provide notice to a potential purchaser of vehicle option packages added to a vehicle. The disclosed embodiments may enable customizable option packages that can be automatically included in a vehicle label as at generation of the label, according to a rule set.

### COPYRIGHT NOTICE

© 2015 DealerAddendums Inc. A portion of the disclosure of this patent document contains material that is subject to copyright protection. The copyright owner has no objection to the facsimile reproduction by anyone of the patent document or the patent disclosure, as it appears in the Patent and Trademark Office patent file or records, but otherwise reserves all copyright rights whatsoever. 37 C.F.R. §1.71(d).

### TECHNICAL FIELD

The present disclosure is directed to systems and methods for labeling vehicles, and more particularly to systems and methods for generating vehicle addendums for customizable option packages.

### BACKGROUND

The Automobile Information Disclosure Act of 1958 mandated that, in the United States, a window sticker or a label be displayed on new automobiles to provide disclosure of certain information. A Monroney sticker or window sticker is a label that is displayed in all new automobiles to meet the requirements for listing certain official information about the vehicle.

The Monroney sticker is required to be affixed to the side window or windshield of every new car sold in the United States and can only be removed by the consumer. A fine, per vehicle, for each offense is authorized if the sticker is missing, and other fees and penalties are authorized if the sticker is altered illegally (including imprisonment). The sticker may be required to include information such as: the manufacturer's suggested retail price (MSRP); engine and transmission specifications; standard equipment and warranty details; optional equipment and pricing; city and highway fuel economy ratings, as determined by the Environmental Protection Agency (EPA); and crash test ratings as determined by the National Highway Traffic Safety Administration.

New automobiles arrive to car dealerships with a Monroney sticker, per the requirements, listing information for then present features of the vehicle. However, dealerships may have customary practices to install or otherwise add options to the vehicle that increase the value of the vehicle but that are not listed on the Monroney sticker. Examples of options may include window tinting, paint protection film (e.g., Clearbra®, Invisible Bra®) in certain areas, tire packages, and the like. These options may be installed by the dealers for a variety of purposes including an intent to improve the product being sold to the consumer.

Challenges arise when consumers view the Monroney sticker price of a vehicle and are not aware of the additional options, or the price of those options. When discussing the purchase price of a vehicle, disparity arises when the customer understands the value of the automobile to be the sticker price on the Monroney sticker, and is not aware of the dealer-added options and their price or value.

Some dealers provide a dealer addendum on vehicles as a supplement to the Monroney sticker. The dealer addendum may provide notice of additional options (and the price of such). Often, dealers handwrite dealer addendums because systems and methods for efficiently and effectively generating such dealer addendums are not presently available.

### SUMMARY

The present disclosure provides systems and methods for generating vehicle labels, such as dealer addendums. The vehicle labels may provide notice to a potential purchaser of vehicle option packages added to a vehicle. The disclosed embodiments may enable customizable option packages that can be included in a vehicle label according to a rule set.

### BRIEF DESCRIPTION OF THE DRAWINGS

Additional aspects and advantages will be apparent from the following detailed description of preferred embodiments, which proceeds with reference to the accompanying drawings, in which:

FIG. 1 is a vehicle labeling system, according to one embodiment of the present disclosure.

FIG. 2 is a user interface of an inventory engine of a vehicle labeling system, according to one embodiment.

FIG. 3 is a user interface of an options generator of a vehicle labeling system, according to one embodiment.

FIG. 4 is another user interface of an options generator of a vehicle labeling system, according to one embodiment.

FIG. 5 is a user interface of a label generator of a vehicle labeling system, according to one embodiment.

FIG. 6 is a customized vehicle addendum generated by a vehicle labeling system, according to one embodiment.

FIG. 7 is a flow diagram of a method for generating a vehicle addendum, according to one embodiment.

### DETAILED DESCRIPTION OF PREFERRED EMBODIMENTS

The present disclosure will be better understood from the detailed description provided below and from the drawings of various embodiments, methods, and examples herein. These specifics, however, are provided for explanatory purposes that help the various embodiments of the disclosure to be better understood. The invention should therefore not be limited by the described embodiments, methods, and examples, but by all embodiments and methods within the scope and spirit of the invention as claimed.

A Monroney sticker or window sticker is a label that is affixed for display on all new automobiles to meet requirements that certain official information about the vehicle be provided to consumers (e.g., potential purchasers of a vehicle). The Monroney sticker may include information such as: the manufacturer's suggested retail price (MSRP); engine and transmission specifications; standard equipment and warranty details; optional equipment and pricing; city and highway fuel economy ratings, as determined by the Environmental Protection Agency (EPA); and crash test ratings as determined by the National Highway Traffic Safety Administration.

A new automobile arrives to a car dealership with a Monroney sticker, as required, listing information for the state of the vehicle. The dealership may then install or otherwise add options to the vehicle that increase the value of and improve the vehicle, but that are not listed on the Monroney sticker. Examples of options may include window tinting, paint protection film (e.g., Clearbra®, Invisible Bra®) in certain areas, tire packages, and the like.

Potential purchasers of the vehicle view the Monroney sticker price of a vehicle and are not aware of the additional options, or the price of those options, and unless a dealer addendum is added to the vehicle to supplement the information on the Monroney sticker, a customer of the dealership may be confused when the cost of the vehicle is purported to be more than the MSRP on the Monroney sticker. A dealer addendum can make customers aware of the dealer-added options and their price or value.

The present disclosure provides systems and methods for generating vehicle labels, such as dealer addendums. The disclosed embodiments enable customizable option packages that can be included in a vehicle label according to a rule set.

A system for generating a vehicle addendum, according to one embodiment, may include one or more processors, a memory, an inventory engine, an options generator, a label generator, and a template generator. The memory may be in electrical communication with the one or more processors to store electronic vehicle records and default option records.

The inventory engine may be one or more modules, logic, and/or computing devices configured to receive vehicle information for one or more vehicles and to generate an electronic vehicle record for each of the one or more vehicles. The vehicle record may be stored in the memory. The vehicle record that is generated may include the vehicle information, which may include one or more vehicle characteristics.

The options generator may be one or more modules, logic, and/or computing devices configured to receive item input, including item details for an item to be optionally added to a vehicle. The options generator may generate a default option record that is stored in the memory, and the default option record may include the item details. The option record may include item details for a plurality of items to be added to a vehicle. For example, the options generator may be configured to receive item input including item details for a first item and item details for a second item to be optionally added to a vehicle. The options generator may generate a default option record that includes the item details of the first item and the item details of the second item. The item input may include application mode input that indicates whether the item details of the default option record are to be automatically added to vehicle addendums or manually added to vehicle addendums. The item input may include rule input specifying a rule for the default option record. The rule is to be applied when the application mode indicates the item details are to be automatically added to vehicles. The rule may define a vehicle characteristic of a grouping of vehicles for which the item details of the default option record are to be automatically added to a corresponding vehicle addendum when it is generated.

The label generator may be one or more modules, logic, and/or computing devices configured to receive request input requesting a vehicle addendum for a given vehicle and, in response, generate the vehicle addendum. The request input may include option input indicating a selection of the default option to be included on the label. The label generator may be configured to include on the vehicle addendum the vehicle information for the given vehicle and the item details of the default option record. The label generator may be configured, for example, to compare a vehicle characteristic specified in a rule of a first default option (including a first item) with the one or more vehicle characteristic of a vehicle record of the given vehicle to determine whether the given vehicle is within the grouping of vehicles to which item details of the first item will be automatically added to the vehicle addendum. If the given vehicle is within the grouping of vehicles, the label generator would then include on the vehicle addendum the vehicle information for the given vehicle and item details of the first item. If the given vehicle is outside the grouping of vehicles, the label generator would then include on the vehicle addendum the vehicle information for the given vehicle, and item information for any other pertinent default options (e.g., for which the vehicle is within the specified vehicle grouping) and would exclude from the vehicle addendum the item details of the first item. Stated differently, the label generator may include on the vehicle addendum item details of a second default option, while excluding item details of the first default option.

The template generator is configured to receive template input specifying a format for a vehicle addendum and generate an addendum template that is stored in memory. The addendum template may be used by the label generator to generate the vehicle addendum. The label generator may arrange the vehicle information and the item details according to the addendum template. The template input may specify an arrangement of the vehicle information and the item details on the vehicle addendum. The template input may specify a logo to be included on the vehicle addendum.

The system for generating a vehicle addendum may further include a network interface configured to communicate over a communication network with one or more client computing devices. The vehicle information is received via the network interface, over a network from a dealer client computing device. The vehicle information may be received as user input manually entered into a user interface of the dealer client computing device. The vehicle information may be received over the network as an export file from a dealer management system on the dealer client computing device. The vehicle information may be received automatically from a dealer management system on the dealer client computing device.

A method for generating a vehicle addendum, according to one embodiment, may be implemented on a computing device. The method may include receiving, at a computing device, item input. The item input may include item details for an item to be optionally added to a vehicle. The item input received may include item details for a first item and item details of a second item to be optionally added to a vehicle, in which case the default option record may include the item details of the first item and the item details of the second item. The item input may include application mode input that indicates whether the item details of the default option record are to be automatically added to vehicle addendums or manually added to vehicle addendums.

The method may include generating, by the computing device, a default option record that includes the item details. The method may include receiving at the computing device vehicle information for a vehicle. The method may include generating at the computing device an electronic vehicle record for the vehicle. The vehicle record may include the vehicle information, which includes one or more vehicle characteristics. The method may include receiving, at the computing device, request input requesting a vehicle addendum for the vehicle. The request input received may include option input indicating a selection of the default option to be included on the vehicle addendum. In response to the request input, the requested vehicle addendum may be generated to include on the vehicle addendum the vehicle information for the vehicle and the item details of the default option record. The generated vehicle addendum may be transmitted over a network to a client computing device.

The application mode may indicate that the item details are to be automatically added to vehicles, and the item input may further include rule input specifying a rule for the default option record. The rule may define a vehicle characteristic of a grouping of vehicles for which the item details of the default option record are to be automatically added to the vehicle addendum.

The method may further include comparing the vehicle characteristic specified in the rule with the one or more vehicle characteristic of the vehicle record of the vehicle to determine whether the vehicle is within the grouping of vehicles such that item details of the first item will be automatically added to the vehicle addendum. If the vehicle is within the grouping of vehicles to which the item details of the first item will be automatically added, the vehicle addendum is generated to include the vehicle information for the given vehicle and item details of the first item. If the given vehicle is outside the grouping of vehicles to which the item details of the first item will be automatically added, the vehicle addendum is generated to include the vehicle information for the given vehicle and to not include (e.g., by excluding) the item details of the first item. The vehicle addendum may also be generated to include item details of a second default option for which the vehicle is within a grouping of vehicles specified by vehicle characteristics of a rule of the second default option.

The method may further include receiving template input specifying a format for a vehicle addendum. An addendum template may be generated and stored in memory. The vehicle addendum is generated based on the addendum template. In other words, the vehicle information and the item details are arranged according to the addendum template.

The features of the systems and methods will now be described with reference to the drawings summarized above. Throughout the drawings, reference numbers are reused to indicate correspondence between referenced elements. In addition, the first digit of each reference number indicates the figure in which the element first appears. The drawings, associated descriptions, and specific implementation are provided to illustrate embodiments of the invention, and not to limit the scope of the invention. The scope of the invention is defined by the appended claims.

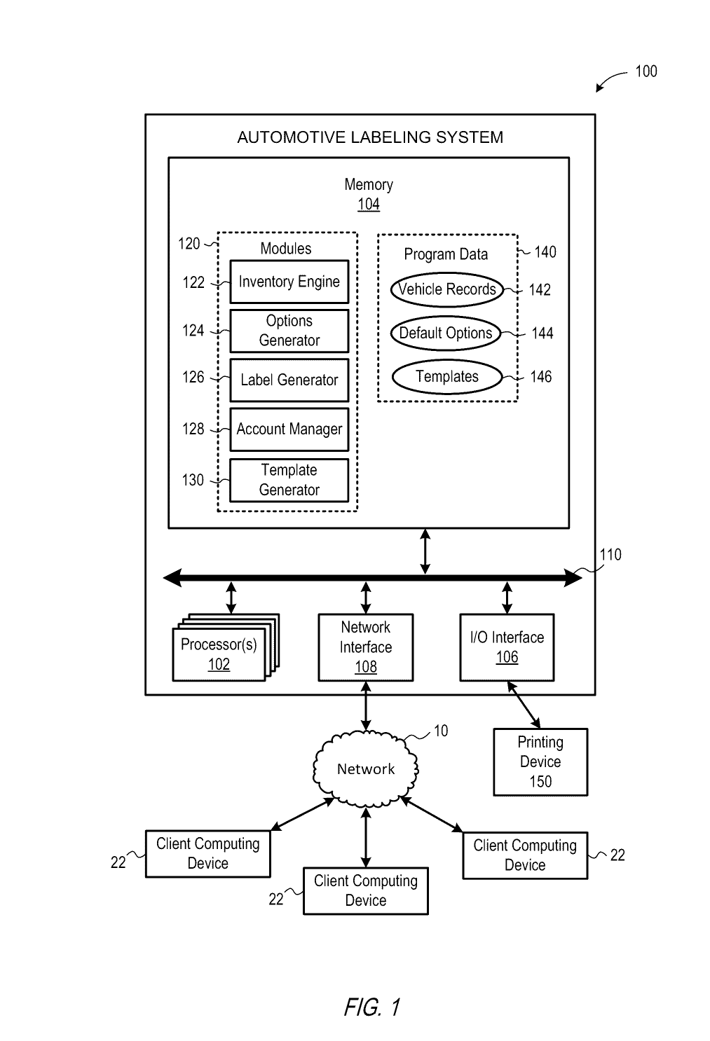

FIG. 1 is an automotive labeling system 100, according to one embodiment of the present disclosure. The system 100 may generate labels for automobiles, such as addendums that may indicate additional features, options, additions, and the like added to an automobile by a seller of a vehicle, such as an auto dealer. The system 100 may include one or more processors 102, a memory 104, an input/output interface 106, a network interface 108, and a system bus 110. The system 100 may be a system for generating vehicle addendums.

The one or more processors 102 may include one or more general purpose devices, such as an Intel®, AMD®, or other standard microprocessor. The one or more processors 102 may include a special purpose processing device, such as ASIC, SoC, SiP, FPGA, PAL, PLA, FPLA, PLD, or other customized or programmable device. The one or more processors 102 perform distributed (e.g., parallel) processing to execute or otherwise implement functionalities of the present embodiments. The one or more processors 102 may run a standard operating system and perform standard operating system functions. It is recognized that any standard operating systems may be used, such as, for example, Microsoft® Windows®, Apple® MacOS®, Disk Operating System (DOS), UNIX, IRJX, Solaris, SunOS, FreeBSD, Linux®, ffiM® OS/2® operating systems, and so forth.

The memory 104 may include static RAM, dynamic RAM, flash memory, one or more flip-flops, ROM, CD-ROM, DVD, disk, tape, or magnetic, optical, or other computer storage medium. The memory 104 may include a plurality of program modules 120 and a program data 140.

The program modules 120 may include all or portions of other elements of the system 100. The program modules 120 may run multiple operations concurrently or in parallel by or on the one or more processors 102. In some embodiments, portions of the disclosed modules, components, and/or facilities are embodied as executable instructions embodied in hardware or in firmware, or stored on a non-transitory, machine-readable storage medium. The instructions may comprise computer program code that, when executed by a processor and/or computing device, cause a computing system to implement certain processing steps, procedures, and/or operations, as disclosed herein. The modules, components, and/or facilities disclosed herein may be implemented and/or embodied as a driver, a library, an interface, an API, FPGA configuration data, firmware (e.g., stored on an EEPROM), and/or the like. In some embodiments, portions of the modules, components, and/or facilities disclosed herein are embodied as machine components, such as general and/or application-specific devices, including, but not limited to: circuits, integrated circuits, processing components, interface components, hardware controller(s), storage controller(s), programmable hardware, FPGAs, ASICs, and/or the like. Accordingly, the modules disclosed herein may be referred to as controllers, layers, services, engines, facilities, drivers, circuits, and/or the like.

The memory 104 may also include program data 140. Data generated by the system 100, such as by the program modules 120 or other modules, may be stored on the memory 104, for example, as stored program data 140. The stored program data 140 may be organized as one or more databases. In certain embodiments, the program data 140 may be stored in a database system. The database system may reside within the memory 104. In other embodiments, the program data 140 may be remote, such as in a distributed computing and/or storage environment. For example, the program data 140 may be stored in a database system on a remote computing device.

The input/output interface 106 may facilitate interfacing with one or more input devices and/or one or more output devices. The input device(s) may include a keyboard, mouse, touch screen, light pen, tablet, microphone, sensor, or other hardware with accompanying firmware and/or software. In the illustrated embodiment of FIG. 1, the output device is a printing device 150. The output device(s) may include a monitor or other display, printer, speech or text synthesizer, switch, signal line, or other hardware with accompanying firmware and/or software.

The network interface 108 may facilitate communication with other computing devices and/or networks 10, such as the Internet and/or other computing and/or communications networks. The network interface 108 may be equipped with conventional network connectivity, such as, for example, Ethernet (IEEE 802.3), Token Ring (IEEE 802.5), Fiber Distributed Datalink Interface (FDDI), or Asynchronous Transfer Mode (ATM). Further, the computer may be configured to support a variety of network protocols such as, for example, Internet Protocol (IP), Transfer Control Protocol (TCP), Network File System over UDP/TCP, Server Message Block (SMB), Microsoft® Common Internet File System (CIFS), Hypertext Transfer Protocols (HTTP), Direct Access File System (DAFS), File Transfer Protocol (FTP), Real-Time Publish Subscribe (RTPS), Open Systems Interconnection (OSI) protocols, Simple Mail Transfer Protocol (SMTP), Secure Shell (SSH), Secure Socket Layer (SSL), and so forth.

The system bus 110 may facilitate communication and/or interaction between the other components of the system, including the one or more processors 102, the memory 104, the input/output interface 106, and the network interface 108.

As noted, the system 100 also includes various program modules 120 (or engines, elements, or components) to implement functionalities of the system 100, including an inventory engine 122, an options generator 124, a label generator 126, an account manager 128, and/or a template generator 130. These elements may be embodied, for example, at least partially in the program modules 120. In other embodiments, these elements may be embodied or otherwise implemented in hardware of the system 100. The system 100 also includes vehicle records 142, default options 144, and addendum templates 146 that may be stored in the program data 140, which may be generated, accessed, and/or manipulated by the program modules 120.

The inventory engine 122 is configured to receive vehicle information for one or more vehicles and to generate an electronic vehicle record 142 for each of the one or more vehicles. The inventory engine 122 may receive the vehicle information via user input to the input/output interface 106. The inventory engine 122 may receive the vehicle information via a client computing device 22. The vehicle information may be received as an output file from, or electronically directly from, a dealer management system. For example, a dealer management system running on a client computing device 22 of a dealer may be in communication with the system 100 via the network 10 and may send automatic updates of vehicles in the dealer's inventory that are added, deleted, or changed. In another example, the dealer management system may export an electronic inventory report, an inventory delta (change) report, or the like. The exported report may be transmitted automatically, sent by email, transmitted by a file transfer protocol, or otherwise electronically communicated to and received by the inventory engine 122. The inventory engine 122 generates a vehicle record 142 for each vehicle for which information is received. The vehicle record 142 is stored in the program data in the memory 104. The vehicle record 142 that is generated may include all or a portion of the vehicle information, which may include one or more vehicle characteristics.

The options generator 124 is configured to receive item input, which may include item details for an item to be optionally added to a vehicle. The item input may be received from a user via a user interface. A car dealership employee may provide the item input via a user interface in a web browser on a client computing device 22. Examples of items that may be added to a vehicle may include window tinting, paint protection film (e.g., Clearbra®, Invisible Bra®), tire packages, wheels, lift kits, and the like. The item details may be used by the options generator 124 to generate a default option 144 that is stored in the memory. For example, a dealer may often tint windows of sports cars received, preparatory to sale of these vehicles. The dealer may wish to create a default option 144 for window tinting, which can be added to dealer addendums generated by the system 100, either manually or automatically based on a rule for sports cars. The option input may include item details for a single item or for a plurality of items. For example, the options generator 124 may be configured to receive item input including item details for a first item and item details for a second item to be optionally added to a vehicle. The item input may also include application mode input that indicates whether the item details of the default option record 144 are to be automatically added to vehicle addendums or manually added to vehicle addendums. The item input may also include rule input specifying a rule for the default option record 144 to be applied when the application mode indicates the item details are to be automatically added to vehicles. The rule may define a vehicle characteristic of a grouping of vehicles for which the item details of the default option record 144 are to be automatically added to a corresponding vehicle addendum when it is generated. The options generator 124 uses the item input to generate the default option record 144. The options generator 124 uses the item input to generate a default option record 144 that may be stored in program data 140 in the memory 104. The default option record 144 includes all or a portion of the item input, including the item details of any items.

The label generator 126 is configured to receive request input requesting a vehicle addendum for a given vehicle record 142 and, in response, generate the requested vehicle addendum. The request input may include option input indicating a selection of a default option to be included on the vehicle addendum. The request input may be received from a user via a user interface. The label generator 126 may be configured to include on the vehicle addendum the vehicle information for the given vehicle and the item details of one or more default option records 144, as specified by a user or by a rule of the one or more default option records 144.

In the situation where the default option record 144 is indicated to be automatically applied in vehicle addendums based on a rule of a default option record 144, the label generator 126 may compare a vehicle characteristic specified in the rule with the one or more vehicle characteristics of a given vehicle record 142 for which a dealer addendum has been requested. The vehicle characteristics of the given vehicle record 142 are compared to the vehicle characteristic specified in the rule to determine whether the given vehicle is within the grouping of vehicles to which item details of the default option record 144 are to be automatically added to the vehicle addendum. If the given vehicle is within the grouping of vehicles, the label generator 126 would then include on the vehicle addendum the vehicle information for the given vehicle and item details of the items in the default option record 144. If the given vehicle is not within the grouping of vehicles, the label generator 126 would then exclude from the vehicle addendum the item details of the items in the default option record 144. The label generator may compare vehicle characteristics of the given vehicle record 142 with the one or more vehicle characteristics specified in the rule of a plurality of default option records 144. Accordingly, the label generator 126 may generate the vehicle addendum to include item details of a second default option record 144, while excluding item details of a first default option record 144.

The account manager 128 receives user data indicating information regarding a user of the system 100 and may generate and manage user accounts. The user data may include a username, a password, contact information, and associated vehicle records 142, default options 144, and templates.

The template generator 130 receives template input specifying a format for a vehicle addendum and generating an addendum template 146 that is stored in the memory 104. The addendum template 146 may be used by the label generator 126 to generate a vehicle addendum. The addendum template 146 may be associated with one or more user accounts, such that vehicle addendums requested by those users are generated based on the addendum template 146. The label generator 126 arranges the vehicle information and the item details according to the addendum template 146. The template input may specify an arrangement of the vehicle information and the item details on the vehicle addendum. The template input may specify a logo to be included on the vehicle addendum.

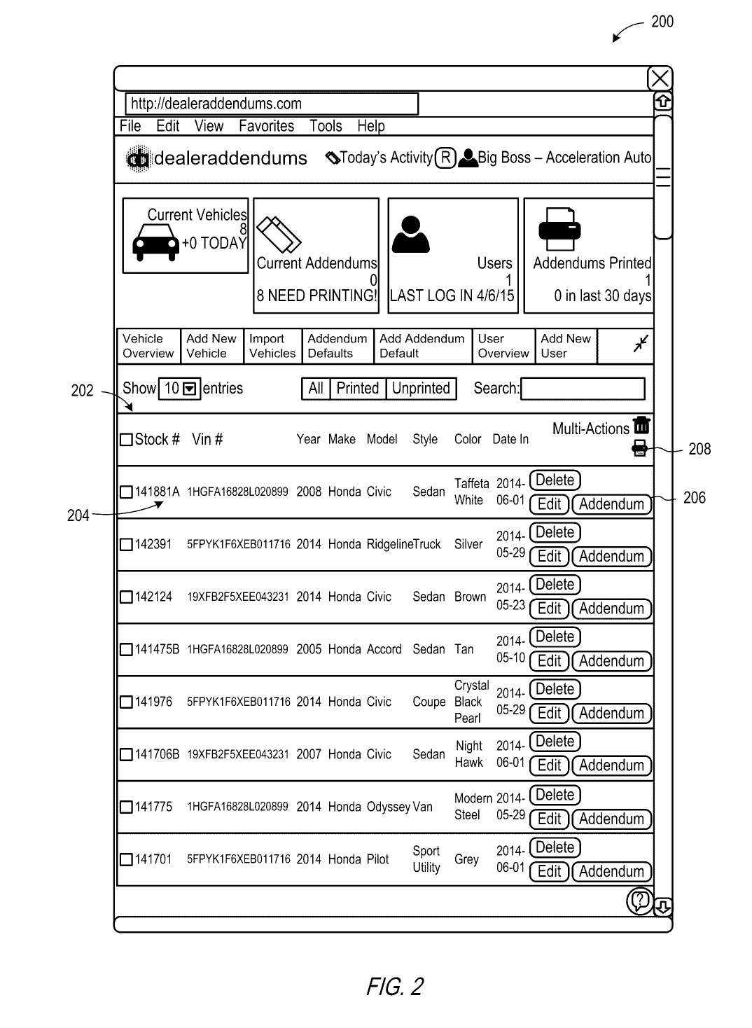

FIG. 2 is a user interface 200 of an inventory engine of a vehicle labeling system, according to one embodiment. The user interface 200 provides an inventory listing 202, which lists vehicle information 204 from one or more vehicle records. The vehicle information 204 may include a dealer stock number, a vehicle identification number (VIN), a year of the vehicle, a make and model of the vehicle, a style, a color, and the like. The listing 202 may also include an addendum input component 206, which may be manipulated by a user to request a vehicle addendum for a given vehicle record. The addendum input component 206, when manipulated, may actuate a label generator to generate a vehicle addendum for the given vehicle record. The user interface may further include a multi-action input component 208 to request a vehicle addendum for each of a plurality of vehicle records.

The user interface 200 and other user interfaces described herein and shown in the figures may be presented to a user over a network, such as via a web browser. A web browser is typically a software program that permits a user to access various Web servers, including content providers, through the network 20. The web browser may include the Microsoft® Internet Explorer developed by Microsoft, Corporation, Safari® developed by Apple Inc., and Chrome® developed by Google Inc.; however, other types of access software may also be used to implement a Web browser, such as, for example, other types of Internet browsers, customer network browsers, two-way communications software, cable modem software, point-to-point software, and the like.

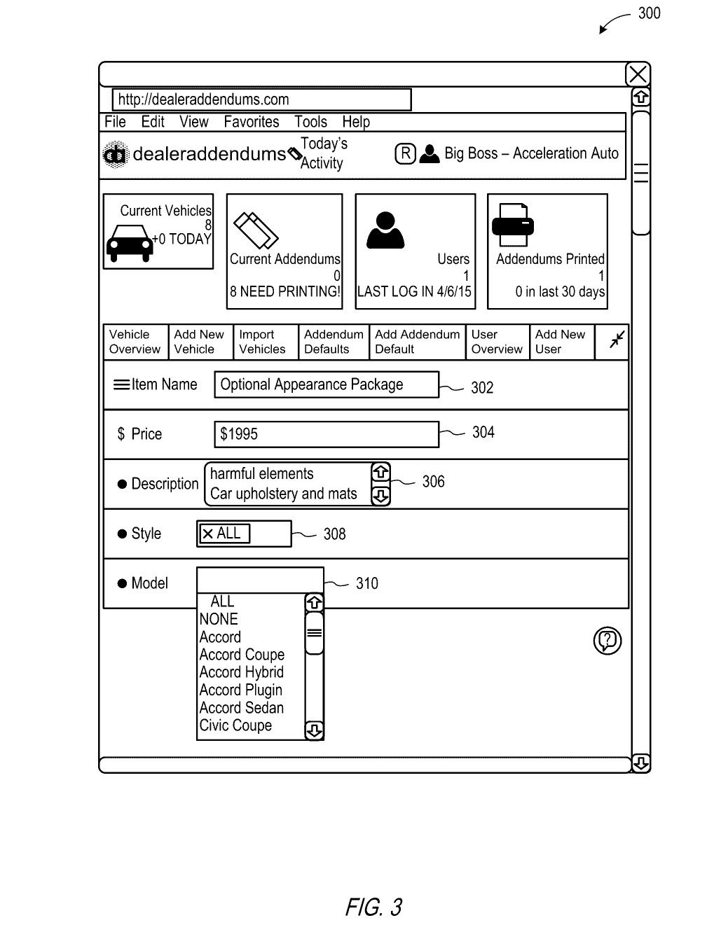

FIG. 3 is a user interface 300 of an options generator of a vehicle labeling system, according to one embodiment. The user interface 300 provides a plurality of input fields for receiving item input for items that may be added to a vehicle. The item input received may be used by the options generator to generate a default option record that is stored in memory. The input fields may include an item name input field 302 to indicate a name for the one or more items of the default option. The input fields may include a price input field 304 to indicate a price for the one or more items of the default option record. The input fields may include a description input field 306 to provide information concerning the one or more items of the default option record. The description input field 306 may allow specification of additional or supplemental information, or item details, concerning the one or more items of the default option record.

The input fields may also include one or more rules input fields to receive rule input specifying rule parameters of a rule for the default option record. The rule may be relevant when an application mode indicates the item details are to be automatically added to vehicles. In the illustrated embodiment, the rules input fields include a style input field 308 and a model input field 310. The style input field 308 enables specification of which style of vehicles the default option record should be automatically applied. The style input field 308 receives a rule parameter or information (e.g., a vehicle characteristic) that can be used to generate a rule parameter as to a style of vehicle to which the default option record should be applied when a corresponding vehicle addendum is generated. The model input field 310 enables specification of which model of vehicles the default option record should be automatically applied. The style model field 310 receives a rule parameter or information (e.g., a vehicle characteristic) that can be used to generate a rule parameter as to a model of vehicle to which the default option record should be applied when a corresponding vehicle addendum is generated. For the illustrated user interface 300, if any input or value is provided via the rules input fields, the application mode indicates automatic application of the default option (e.g., inclusion of item details) on vehicle addendums according to the rule. In other words, the item details of the default option would be automatically included in vehicle addendums for any vehicles having characteristics matching the style and/or model of the rule of the default option.

In FIG. 3, the user interface 300 is shown receiving item input pertaining to an Optional Appearance Package which includes items such as paint sealant protection from harmful elements and car upholstery and mats throughout, at a price of $1995. The user interface 300 is also receiving rule input specifying that the item details should be included in vehicle addendums for corresponding vehicles of any (e.g., “All”) style and yet to be indicated model(s).

As can be appreciated, a variety of different input fields may be utilized to provide item input. Input components of a variety of types may be employed on the user interface 300. Moreover, any of a variety of rule parameters beyond style and model may be incorporated into a rule set for a default options record. For example, other rule parameters may include, but are not limited to, color, year, mileage, towing capacity, engine size, and the like.

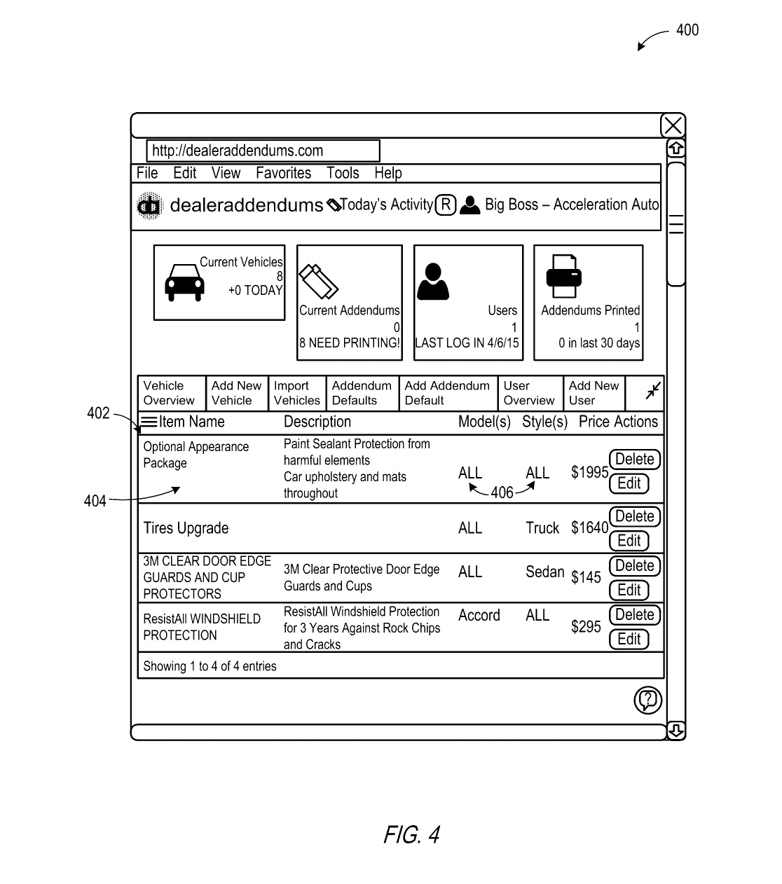

FIG. 4 is another user interface 400 of an options generator of a vehicle labeling system, according to one embodiment. The user interface 400 provides a default options listing 402 of default option records generated and available for application in generating vehicle labels such as vehicle addendums. The default options listing 402 lists item details 404 from one or more default option records. The item details 404 may include the item name, description, and price. The listing 402 may also include rule details 406 for each of the one or more default option records. The rule details 406 include model, which indicates one or more models of vehicle to which the default option record should be automatically applied (e.g., included) in the vehicle addendum. The rule details 406 also include style, which indicates one or more styles of vehicle to which the default option record should be automatically applied (e.g., included) in the vehicle addendum. The default options listing 402 may be generated according to the default option records created using, for example, the user interface 300 described above with reference to FIG. 3. The default options listing 402 may also include default option records generated from item input received via other methods, such as via an import file, an electronic protocol, or the like. The default options listing 402 may also include system-configured default option records.

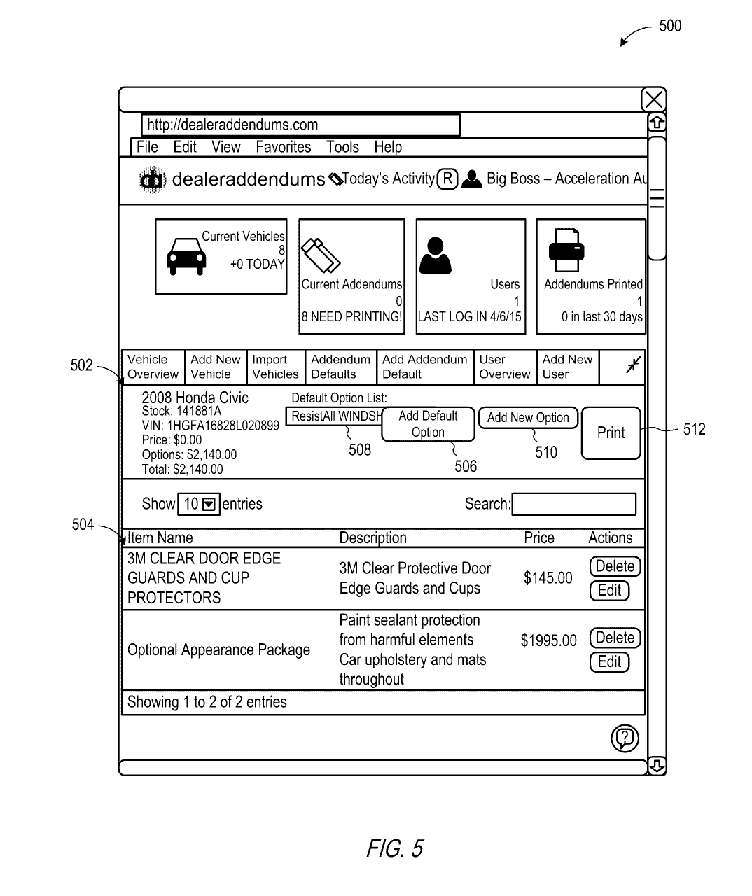

FIG. 5 is a user interface 500 of a label generator of a vehicle labeling system, according to one embodiment. The user interface 500 provides a requested addendum listing 502 and an included options listing 504. The addendum listing 502 provides a list of one or more vehicle records for which a vehicle addendum is to be generated (e.g., printed) by the label generator. The included options listing 504 provides a list of default option records to be included in the vehicle addendum(s). The vehicle records in the addendum listing 502 may be selected, for example, using the user interface 200 described above with reference to FIG. 2. The default option records in the included options listing 504 may be selected based on rule parameters of a rule of the default option record, and may be automatically added to the included options listing 504. The default option records in the included options listing 504 may also be selected manually by user input. The user interface 500 may provide an “add default option” input component 506 that may be manipulated to allow manual selection of default option records from a default option list 508 to include in a vehicle addendum. A new default option input component 510 may be provided to allow creation of new default option records, for example, via the user interface 400 of FIG. 4. A “print” input component 512 may be provided that can be manipulated to cause the label generator to generate a vehicle addendum that includes the vehicle information and the item details of the default option record(s).

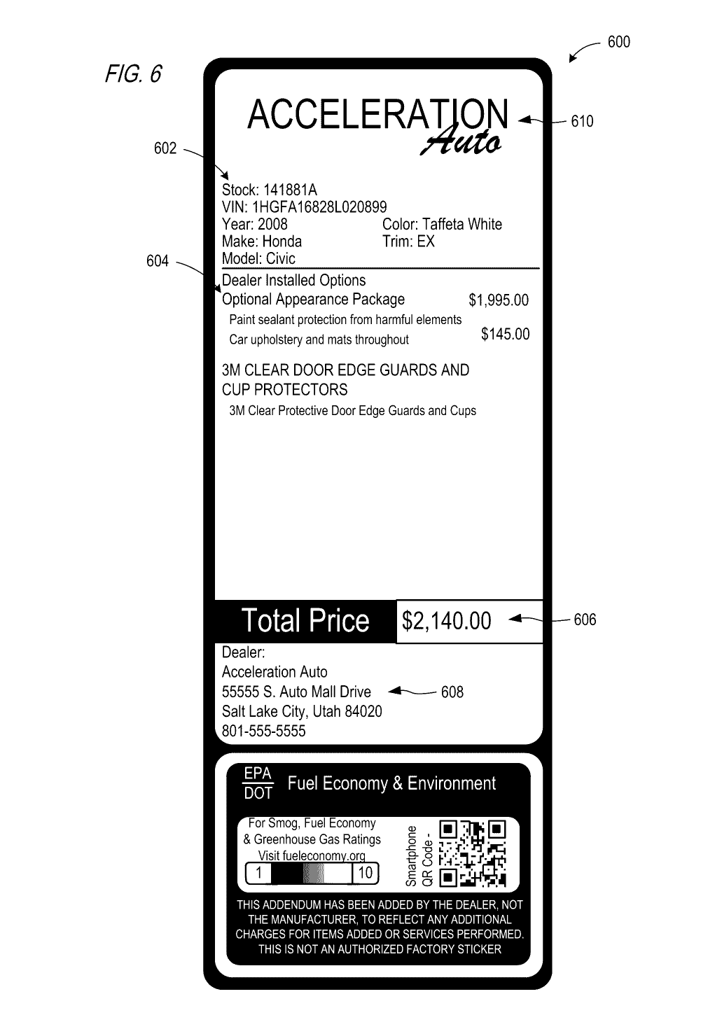

FIG. 6 is a customized vehicle addendum 600 generated by a vehicle labeling system, according to one embodiment. The illustrated vehicle addendum 600 includes vehicle information 602 and item details 604 of one or more default option records. The item details 604 include a price for each item. A total price 606 for all items of the one or more default option records is also provided for the convenience of customers. The vehicle addendum price 606 for all items of the one or more default option records is also provided for the convenience of customers. The vehicle addendum 600 includes the dealer information 608 and may be customized with the dealer logo 610, according to a template.

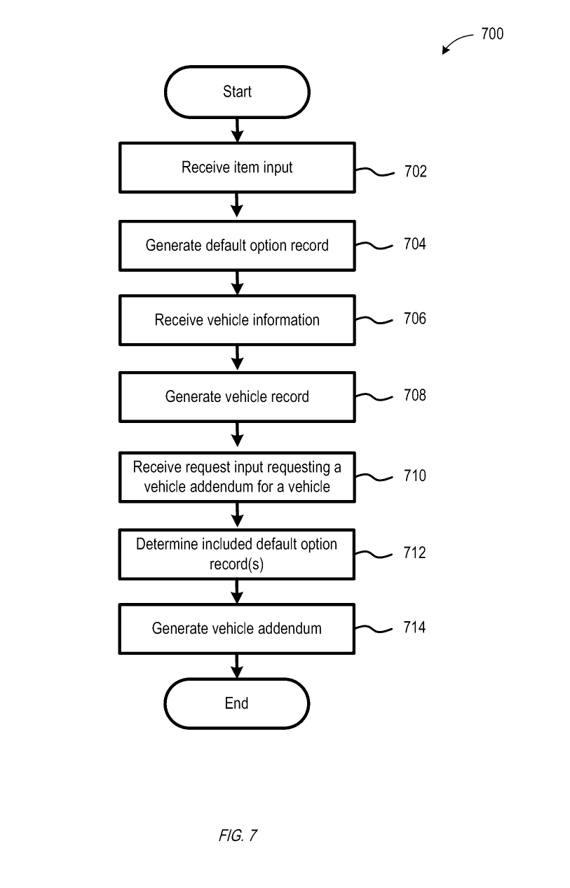

FIG. 7 is a flow diagram of a method 700 for generating a vehicle addendum, according to one embodiment. Item input may be received 702 at a computing device. The item input may include item details for one or more items to be optionally added to a vehicle. The item details provide information that can be added to a vehicle addendum. The item input may also include application mode input that indicates whether the item details of the default option record are to be automatically added to vehicle addendums or manually added to vehicle addendums. The item input may further include rule input specifying a rule for the default option record. The rule may be applicable when the application mode indicates the item details are to be automatically added to vehicle addendums. The rule may include parameters that define one or more vehicle characteristics of a grouping of vehicles for which the item details of the default option record are to be automatically added to the vehicle addendum. The item input is used to generate 704 a default option record on the computing device. The default option record that is generated can include the item details and any application mode and any rules.

Vehicle information is received 706 at a computing device. The vehicle information may include one or more vehicle characteristics, such as make, model, vehicle identification number (VIN), color, year, and the like. An electronic vehicle record is generated 708 for the vehicle. The vehicle record includes the vehicle information, including the one or more vehicle characteristics.

Request input is received 710 requesting a vehicle addendum for a given vehicle. The request input may include option input indicating a selection of a default option record to be included on the vehicle addendum. In response to receiving 710 the request input, included default option records may be determined 712 for inclusion on the vehicle addendum.

The included default option records may be determined 712 based on the option input indicating a selection of a default option record. The pertinent default option records may be determined based on comparing the one or more vehicle characteristics of a vehicle for which a vehicle addendum is being requested or otherwise generated to vehicle characteristic specified in the rule parameters of a rule of a default option record to determine whether the vehicle is within the grouping of vehicles for which the first item will be automatically added to the vehicle addendum. If the vehicle is within the grouping of vehicles to which the item details of a first default option record will be automatically added, the vehicle addendum is generated 714 to include the vehicle information for the given vehicle and item details of the first default option record. As can be appreciated, if the given vehicle is outside the grouping of vehicles to which the item details of the first default option record will be automatically added, the vehicle addendum is generated 714 including the vehicle information for the given vehicle and excluding the item details of the first item. The vehicle addendum may instead include item details of a second default option, for which the vehicle is within a grouping of vehicles specified by vehicle characteristics of a rule of the second default option.

The requested vehicle addendum is generated 712 by including on the vehicle addendum the vehicle information for the vehicle and the item details of any included default option records. The generated 712 vehicle addendum may be transmitted over a network to a client computing device. The generated 712 vehicle addendum may be stored electronically in a database or other storage device. The generated 712 vehicle addendum may be printed to a physical label via a printing device, such as via an input/output interface.

As can be appreciated, other embodiments may include additional steps or may arrange the foregoing steps in a different order.

The foregoing specification has been described with reference to various embodiments, including the best mode. However, those skilled in the art appreciate that various modifications and changes can be made without departing from the scope of the present disclosure and the underlying principles of the invention. Accordingly, this disclosure is to be regarded in an illustrative rather than a restrictive sense, and all such modifications are intended to be included within the scope thereof. Likewise, benefits, other advantages, and solutions to problems have been described above with regard to various embodiments. However, benefits, advantages, solutions to problems, and any element(s) that may cause any benefit, advantage, or solution to occur or become more pronounced are not to be construed as a critical, required, or essential feature or element.

As used herein, the terms “comprises,” “comprising,” or any other variation thereof are intended to cover a non-exclusive inclusion, such that a process, method, article, or apparatus that comprises a list of elements does not include only those elements but may include other elements not expressly listed or inherent to such process, method, article, or apparatus. Also, as used herein, the terms “coupled,” “coupling,” or any other variation thereof are intended to cover a physical connection, an electrical connection, a magnetic connection, an optical connection, a communicative connection, a functional connection, and/or any other connection.

Principles of the present disclosure may be reflected in a computer program product on a tangible computer-readable storage medium having computer-readable program code means embodied in the storage medium. Any suitable computer-readable storage medium may be utilized, including magnetic storage devices (hard disks, floppy disks, and the like), optical storage devices (CD-ROMs, DVDs, Blu-Ray discs, and the like), flash memory, and/or the like. These computer program instructions may be loaded onto a general purpose computer, special purpose computer, or other programmable data processing apparatus to produce a machine, such that the instructions that execute on the computer or other programmable data processing apparatus create means for implementing the functions specified. These computer program instructions may also be stored in a computer-readable memory that can direct a computer or other programmable data processing apparatus to function in a particular manner, such that the instructions stored in the computer-readable memory produce an article of manufacture including instruction means which implement the function specified. The computer program instructions may also be loaded onto a computer or other programmable data processing apparatus to cause a series of operational steps to be performed on the computer or other programmable apparatus to produce a computer-implemented process such that the instructions which execute on the computer or other programmable apparatus provide steps for implementing the functions specified.

Principles of the present disclosure may be reflected in a computer program implemented as one or more software modules. As used herein, a software module or component (e.g., an engine) may include any type of computer instruction or computer-executable code located within a memory device and/or computer-readable storage medium. A software module may, for instance, comprise one or more physical or logical blocks of computer instructions, which may be organized as a routine, a program, an object, a component, a data structure, etc., that perform one or more tasks or implement particular data types.

In certain embodiments, a particular software module may comprise disparate instructions stored in different locations of a memory device, which together implement the described functionality of the module. Indeed, a module may comprise a single instruction or many instructions, and may be distributed over several different code segments, among different programs, and across several memory devices. Some embodiments may be practiced in a distributed computing environment where tasks are performed by a remote processing device linked through a communications network. In a distributed computing environment, software modules may be located in local and/or remote memory storage devices. In addition, data being tied or rendered together in a database record may be resident in the same memory device, or across several memory devices, and may be linked together in fields of a record in a database across a network.

Suitable software to assist in implementing the invention is readily provided by those of skill in the pertinent art(s) using the teachings presented here and programming languages and tools, such as Java, Pascal, C++, C, database languages, APIs, SDKs, assembly, firmware, microcode, and/or other languages and tools.

Embodiments as disclosed herein may be computer-implemented in whole or in part on a digital computer. The digital computer includes a processor performing the required computations. The computer further includes a memory in electronic communication with the processor to store a computer operating system. The computer operating systems may include, but are not limited to, MS-DOS, Windows, Linux, Unix, AIX, CLIX, QNX, OS/2, and Apple. Alternatively, it is expected that future embodiments will be adapted to execute on other future operating systems.

In some cases, well-known features, structures or operations are not shown or described in detail. Furthermore, the described features, structures, or operations may be combined in any suitable manner in one or more embodiments. It will also be readily understood that the components of the embodiments as generally described and illustrated in the figures herein could be arranged and designed in a wide variety of different configurations.

Various operational steps, as well as components for carrying out operational steps, may be implemented in alternate ways depending upon the particular application or in consideration of any number of cost functions associated with the operation of the system, e.g., one or more of the steps may be deleted, modified, or combined with other steps.

While the principles of this disclosure have been shown in various embodiments, many modifications of structure, arrangements, proportions, the elements, materials and components, used in practice, which are particularly adapted for a specific environment and operating requirements, may be used without departing from the principles and scope of this disclosure. These and other changes or modifications are intended to be included within the scope of the present disclosure.

The scope of the present invention should, therefore, be determined only by the following claims.

What is claimed is:

1. A system for generating a vehicle addendum, comprising:
one or more processors;
a memory in electrical communication with the one or more processors to store electronic vehicle records and default option records;
an inventory engine configured to receive vehicle information for one or more vehicles and to generate an electronic vehicle record for each of the one or more vehicles, wherein the vehicle record is stored in the memory and includes the vehicle information, which includes one or more vehicle characteristics;
an options generator configured to receive item input including item details for an item to be optionally added to a vehicle and generate a default option record that is stored in the memory, the default option record including the item details; and
a label generator configured to receive request input requesting a vehicle addendum for a given vehicle and, in response, generate the vehicle addendum, the label generator including on the vehicle addendum the vehicle information for the given vehicle and the item details of the default option record.

2. The system of claim 1, wherein the item input includes application mode input that indicates whether the item details of the default option record are to be automatically added to vehicle addendums or manually added to vehicle addendums.

3. The system of claim 2, wherein the item input includes rule input specifying a rule for the default option record when the application mode indicates the item details are to be automatically added to vehicles, the rule defining a vehicle characteristic of a grouping of vehicles for which the item details of the default option record are to be automatically added to the vehicle addendum.

4. The system of claim 3, wherein the label generator is further configured to compare the vehicle characteristic specified in a rule of a first default option including a first item with the one or more vehicle characteristic of a vehicle record of the given vehicle to determine whether the given vehicle is within the grouping of vehicles to which item details of the first item will be automatically added to the vehicle addendum,
wherein, if the given vehicle is within the grouping of vehicles, the label generator includes on the vehicle addendum the vehicle information for the given vehicle and item details of the first item, and
wherein, if the given vehicle is outside the grouping of vehicles, the label generator includes on the vehicle addendum the vehicle information for the given vehicle and excludes from the vehicle addendum the item details of the first item.

5. The system of claim 4, wherein the label generator further includes on the vehicle addendum item details of a second default option.

6. The system of claim 1, wherein the request input includes option input indicating a selection of the default option to be included on the label.

7. The system of claim 1, further comprising a template generator configured to receive template input specifying a format for a vehicle addendum and generating an addendum template that is stored in memory,
wherein the label generator generates the vehicle addendum and arranges the vehicle information and the item details according to the addendum template.

8. The system of claim 1, wherein the options generator is configured to receive item input including item details for a first item and item details of a second item to be optionally added to a vehicle and generating a default option record that is stored in the memory, the default option record including the item details of the first item and the item details of the second item.

9. The system of claim 1, further comprising a network interface configured to communicate over a communication network with one or more client computing devices.

10. The system of claim 9, wherein the vehicle information is received via the network interface, over a network from a dealer client computing device.

11. A computer-implemented method for generating a vehicle addendum, comprising:
receiving at a computing device item input including item details for an item to be optionally added to a vehicle;
generating by the computing device a default option record that includes the item details;
receiving at the computing device vehicle information for a vehicle;
generating at the computing device an electronic vehicle record for the vehicle, the vehicle record including the vehicle information, which includes one or more vehicle characteristics;
receiving at the computing device request input requesting a vehicle addendum for the vehicle; and
in response to the request input, generating the requested vehicle addendum by including on the vehicle addendum the vehicle information for the vehicle and the item details of the default option record.

12. The method of claim 11, wherein the item input includes application mode input that indicates whether the item details of the default option record are to be automatically added to vehicle addendums or manually added to vehicle addendums.

13. The method of claim 12, wherein, when the application mode indicates the item details are to be automatically added to vehicle addendums, the item input further includes rule input specifying a rule for the default option record, the rule defining a vehicle characteristic of a grouping of vehicles for which the item details of the default option record are to be automatically added to the vehicle addendum.

14. The method of claim 13, further comprising:
comparing the vehicle characteristic specified in the rule with the one or more vehicle characteristic of the vehicle record to determine whether the vehicle is within a grouping of vehicles of a rule of a first default option record, such that item details of the first default option record will be automatically added to the vehicle addendum,
wherein, if the vehicle is within the grouping of vehicles to which the item details of the first default option record are to be automatically added, the vehicle addendum is generated to include the vehicle information for the given vehicle and item details of the first default option record, and
wherein, if the given vehicle is outside the grouping of vehicles to which the item details of the first default option record are to be automatically added, the vehicle addendum is generated including the vehicle information for the given vehicle and excluding the item details of the first item.

15. The method of claim 14, wherein the label generator further includes on the vehicle addendum item details of a second default option for which the vehicle is within a grouping of vehicles specified by vehicle characteristics of a rule of the second default option.

16. The method of claim 11, wherein the request input includes option input indicating a selection of the default option to be included on the vehicle addendum.

17. The method of claim 11, further comprising:
receiving template input specifying a format for a vehicle addendum; and
generating an addendum template that is stored in memory,
wherein the vehicle addendum is generated to arrange the vehicle information and the item details according to the addendum template.

18. The method of claim 11, wherein receiving item input includes receiving item details for a first item and item details of a second item to be optionally added to a vehicle, and wherein the default option record includes the item details of the first item and the item details of the second item.

19. A system for generating a vehicle addendum, comprising:
one or more processors;
a memory in electrical communication with the one or more processors to store electronic vehicle records and default option records;
an inventory engine configured to receive vehicle information for a vehicle and to generate an electronic vehicle record for the vehicle that is stored in the memory, the vehicle record including the vehicle information, which includes one or more vehicle characteristics;
an options generator configured to receive item input including first item details for a first item to be optionally added to a vehicle and generate a first default option record that is stored in the memory, to receive item input including second item details for a second item to be optionally added to a vehicle and generate a second default option record that is stored in the memory; and
a label generator configured to receive request input requesting a vehicle addendum for the vehicle and, in response, generate the vehicle addendum, the label generator including on the vehicle addendum the vehicle information and one or both of the first item details of the first default option record and the second item details of the second default option record.

20. The system of claim 19, wherein the item input includes first rule input specifying a first rule for the first default option record, the first rule defining a vehicle characteristic of a first grouping of vehicles for which the item details of the default option record are to be automatically added to the vehicle addendum,
wherein the item input includes second rule input specifying a second rule for the second default option record, the second rule defining a vehicle characteristic of a grouping of vehicles for which the second item details of the second default option record are to be automatically added to the vehicle addendum, when the second application mode indicates the second item details are to be automatically added to vehicles,
wherein the label generator is further configured to compare the vehicle characteristic specified in the first rule and the vehicle characteristic specified in the second rule with the one or more vehicle characteristic of the vehicle record of the vehicle to determine whether the vehicle is within one or both of the first grouping of vehicles and the second grouping of vehicles and:
if the vehicle is within the first grouping of vehicles, include on the vehicle addendum the first item details;
if the vehicle is outside the first grouping of vehicles, exclude from the vehicle addendum the item details of the first item,
if the vehicle is within the second grouping of vehicles, include on the vehicle addendum the second item details, and
if the vehicle is outside the second grouping of vehicles, exclude from the vehicle addendum the item details of the second item.
